(19) United States
(12) Patent Application Publication
(10) Pub. No.: US 2017/0161469 A1
(43) Pub. Date: Jun. 8, 2017

(54) Drug Efficacy Analysis System and Drug Efficacy Analysis Method

(71) Applicants: Hitachi, Ltd., Chiyoda-ku, Tokyo (JP); Tokyo Women's Medical University, Shinjuku-ku, Tokyo (JP)

(72) Inventors: Takuma SHIBAHARA, Tokyo (JP); Yoshihiro MURAGAKI, Tokyo (JP)

(21) Appl. No.: 15/323,777

(22) PCT Filed: Jul. 2, 2015
(86) PCT No.: PCT/JP2015/069167

§ 371 Date: Jan. 4, 2017

(30) Foreign Application Priority Data
Jul. 7, 2014 (JP) 2014-139785

(51) Int. Cl. G06F 19/00; G06F 17/18

(52) U.S. Cl. CPC G06F 19/702; G06F 17/18; G06F 19/707

(57) ABSTRACT

The present invention enables statistical analysis of medical practice data with a small number of samples. The following steps are included: a model creation step in which a patient's factor information that is factor information relating to occurrence of an adverse event and includes test values before medication is regression-analyzed and a transition of test value after medication is modeled; and a distribution creation step in which factor information of a patient having the same factor information as the factor information of the patient is virtually generated from the factor information of the patient whose transition of the test value was modeled, and a frequency distribution of each piece of the factor information is generated for a patient whose variation of the test value by medication becomes more than or equal to a fixed value among patients having the generated factor information.

### TECHNICAL FIELD

The present invention relates to a system and a method for executing statistical analysis of health care data used in medical institutions, such as a hospital, and providing data relating to effects and side effects of a medicine.

### BACKGROUND ART

In general, since a new medicine has a risk of an adverse event (side effects), the medicine has a tendency that a growth of its sale is blunt immediately after marketing and its profit quickly decreases by generic medicines being sold after termination of a monopoly period by patent expiration etc. Then, it is important in increasing sales opportunities of the medicine to analyze the effect of the new medicine and the tendency of the adverse effect in its early stage and to support effective application of the medicine from immediately after start of the sale.

For example, Patent Literature 1 discloses a method for identifying and providing information about statistical correlation between factors of a patient (age, sex, etc.) and the adverse event.

### CITATION LIST

### Patent Literature

PTL 1: Japanese Patent Application Laid-Open No. 2012-524945

### SUMMARY OF INVENTION

### Technical Problem

However, it is difficult for a doctor and a pharmacist to plan an administration regimen of a medicine from correlation information that there is a relation between a patient's attributes and an adverse event obtained from the conventional technology of Patent Literature 1. Moreover, when a factor that becomes a relation candidate of the adverse event is multilevel values or a continuous value, it is necessary to perform correlation calculation in a whole definition area of the factor, and therefore, an enormous calculation time will be required.

The present invention is made in view of the above, and has an object of providing a drug efficacy analysis system and a drug efficacy analysis method that make it possible to execute statistical analysis of medical practice data with a small number of samples.

### Solution to Problem

In order to address the problem described above and achieve the object, the drug efficacy analysis method according to the present invention is configured to be a drug efficacy analysis method comprising: a model generation step in which the patient's factor information that is factor information relating to occurrence of the adverse event and includes the test values before medication is regression-analyzed and a transition of the test value after medication is modeled; and a distribution generation step in which factor information of a patient having the same factor information as the factor information of the patient is virtually generated from the factor information of the patient whose transition of the test value was modeled, and a frequency distribution for each piece of the factor information is generated for a patient whose variation of the test value by medication becomes more than or equal to a fixed value.

Moreover, the present invention is grasped as a drug efficacy analysis system that executes the above-mentioned drug efficacy analysis method.

### Advantageous Effects of Invention

According to one aspect of the present invention, it becomes possible to perform the statistical analysis of medical practice data with a small number of samples.

### BRIEF DESCRIPTION OF DRAWINGS

FIG. 1 is a diagram showing a flow of processing of a system of drug efficacy analysis by machine learning in an embodiment of the present invention.

FIG. 2 is a diagram showing a configuration of the system of drug efficacy analysis in terms of equipment by the machine learning in the embodiment of the present invention.

FIG. 3 is a diagram showing an outline of the system of drug efficacy analysis by the machine learning in the embodiment of the present invention.

FIG. 4 is a diagram showing an example of health care data in the embodiment of the present invention.

FIG. 5 is a diagram showing a flow of processing for model generation of an occurrence process of a medicine effect in the embodiment of the present invention.

FIG. 6 is a diagram in which prediction test data obtained in the embodiment of the present invention is visualized.

FIG. 7 is a diagram about a distribution for each related factor obtained in the embodiment of the present invention.

FIG. 8 is a diagram showing a flow of processing of computation of a high occurrence group distribution in the embodiment of the present invention.

FIG. 9 is a diagram showing statistics to the related factor in the embodiment of the present invention.

FIG. 10 is a diagram showing a flow in a case of performing prediction of the medicine effect in an individual patient in processing of the system of drug efficacy analysis by the machine learning in the embodiment of the present invention.

### DESCRIPTION OF EMBODIMENTS

In the following, forms to carry out the invention (hereinafter referred to as “embodiments”) are explained referring to drawings suitably. As shown below, in this system, a method that computes statistical frequency distributions and medical statistics of a patient's attributes (for example, age, sex, gene information, etc.) over effects by administration of a medicine (curative effects and an adverse event) and provides them to a user and its system therefore are prepared. Moreover, this system provides means for predicting therapeutic effects and a strength of the adverse event and its occurrence time by the administration of the medicine for each individual patient.

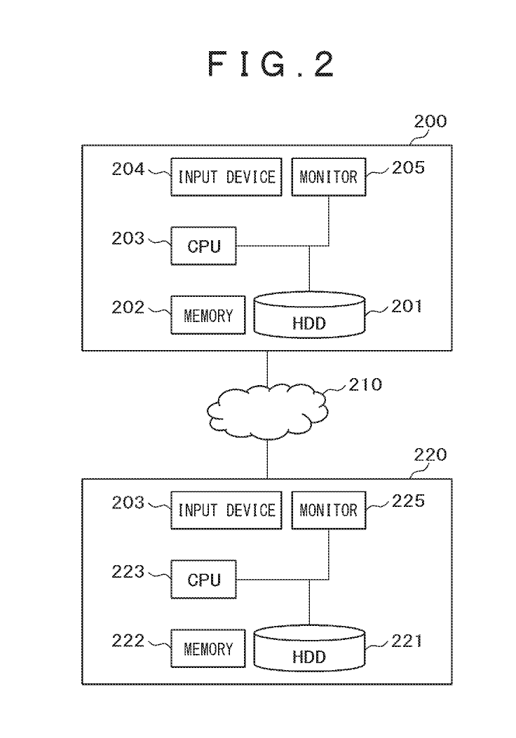

A typical configuration example of a device in an embodiment is shown in FIG. 2. In the embodiment, there are a client terminal 200 and an analysis server 220, which are connected with each other by a network 210. The client terminal 200 is configured with an HDD (hard disk drive) 201 that is an auxiliary storage device, memory 202 that is a main storage device, a CPU (central processing unit) 203, an input device 204 composed of a keyboard and a mouse, and a monitor 205. The analysis server 220 is configured with an HDD 221 that is an auxiliary storage device, memory 222 that is a main storage device, a CPU 223, an input device 224 composed of a keyboard and a mouse, and a monitor 225.

### First Embodiment

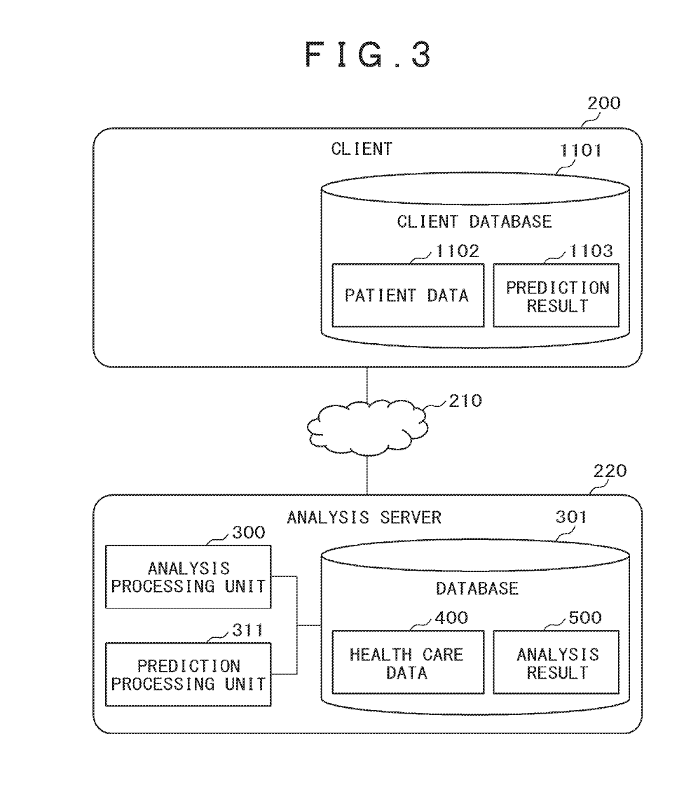

Hereinafter, a first embodiment of the present invention is described, taking a case where an analysis of a factor relating to occurrence of an adverse event (side effect) of an anticancer agent is performed as an example. Explaining it using FIG. 2 and FIG. 3, health care data 400 on which analysis was performed is being saved in the HDD 221, being stored in a database 301, and an analysis processing unit 300 is executed by the CPU 223. When the client terminal 200 establishes connection with the analysis server 220 through the network 210, the health care data 400 is called from the database 301 saved in the HDD 221, and the analysis processing unit 300 is executed by the CPU 223 to generate an analysis result 500 on the memory 222. After that, the analysis processing unit 300 saves the analysis result 500 in the HDD 221, and subsequently distributes the analysis result 500 to the client terminal 200 through the network 210, and the CPU 203 of the client terminal 200 displays the analysis result 500 on the monitor 205.

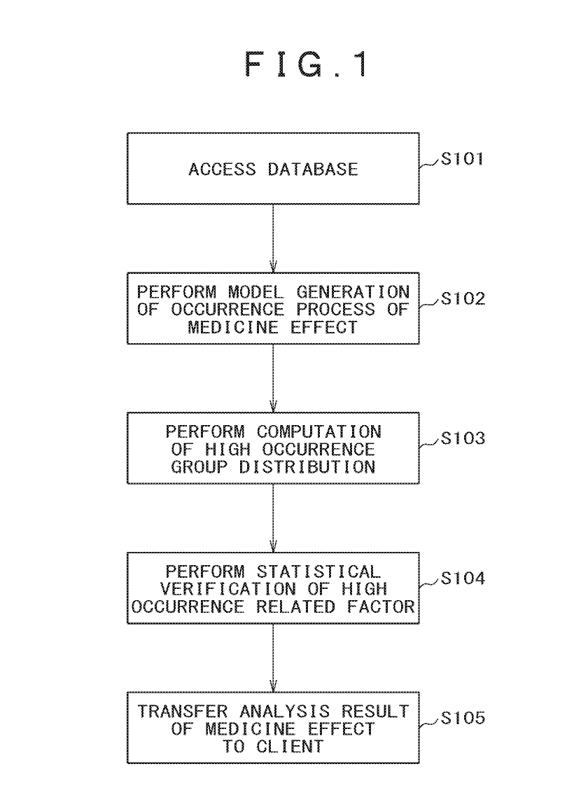

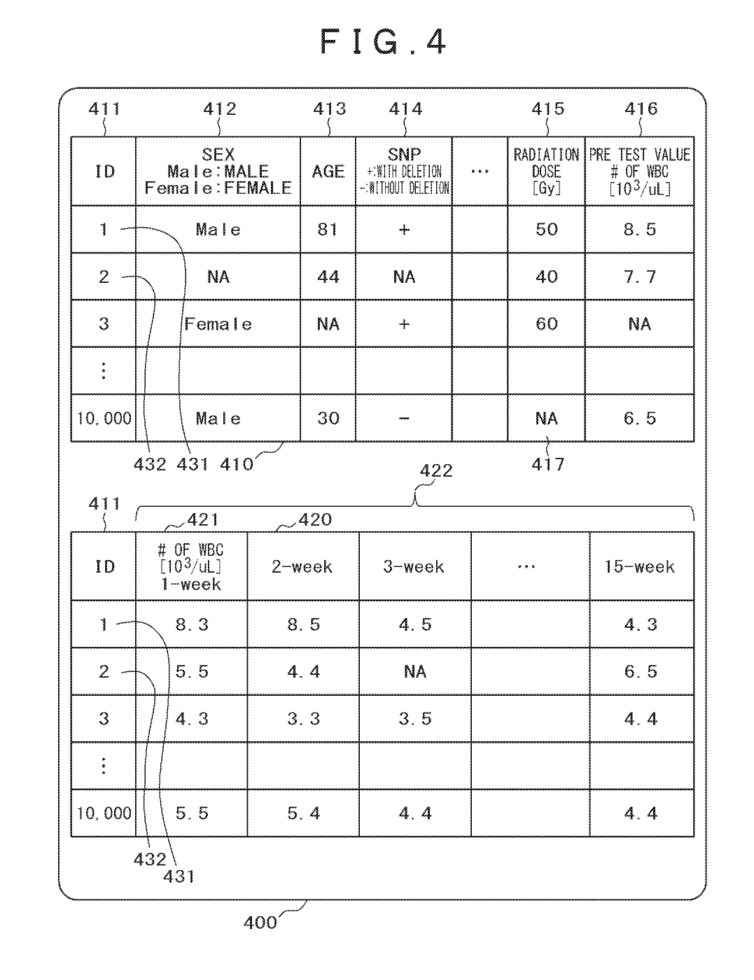

A flow of processing executed in the analysis processing unit 300 is explained using FIG. 1. In S101, the health care data 400 is read from the database 301. Here, explaining the health care data 400 stored in the database 301 using FIG. 4, the health care data 400 is configured with intrinsic data 410 that is storing the patient's factor information and test data 420 for judging an effect of administered medicine (in this embodiment, an adverse event of the anticancer agent). A unique ID (411) is assigned to a patient, and can associate the intrinsic data 410 and the test data 420.

The intrinsic data 410 includes sex 412 and age 413 of a patient. Moreover, in gene-related information 414 of the intrinsic data 410, existence of information of gene deletion by single nucleotide polymorphism (SNP) and existence of chromosome deletion are described. Furthermore, the intrinsic data 410 is composed of radiation dose 415 by radiation therapy, white blood count 416 that is the test value before medication, etc. Although the intrinsic data 410 includes information described in an electronic medical record in a hospital, the five items of 412 to 416 are illustrated in FIG. 4 because of ease of explanation, as one example. Incidentally, notation NA (for example, 417) appearing in 410 and 420 of FIG. 4 means that a value is unknown. Like this, the intrinsic data 410 includes factor information showing physical features of a patient and, hereinafter, these pieces of the factor information relating to the patient's features are referred to as related factors.

The test value of the white blood count after medication is stored in the test data 420 for every week. The test values consist of time series data of not only white blood cells but also other blood cells (a red blood count, a platelet count, etc.), biochemical test values of GOT (glutamic oxaloacetic transaminase) and GPT (glutamic pyruvic transaminase), a tumor marker, etc. Since many anticancer agents have a bone marrow suppression action, the following explains a case where the white blood count is used as a test value as an example.

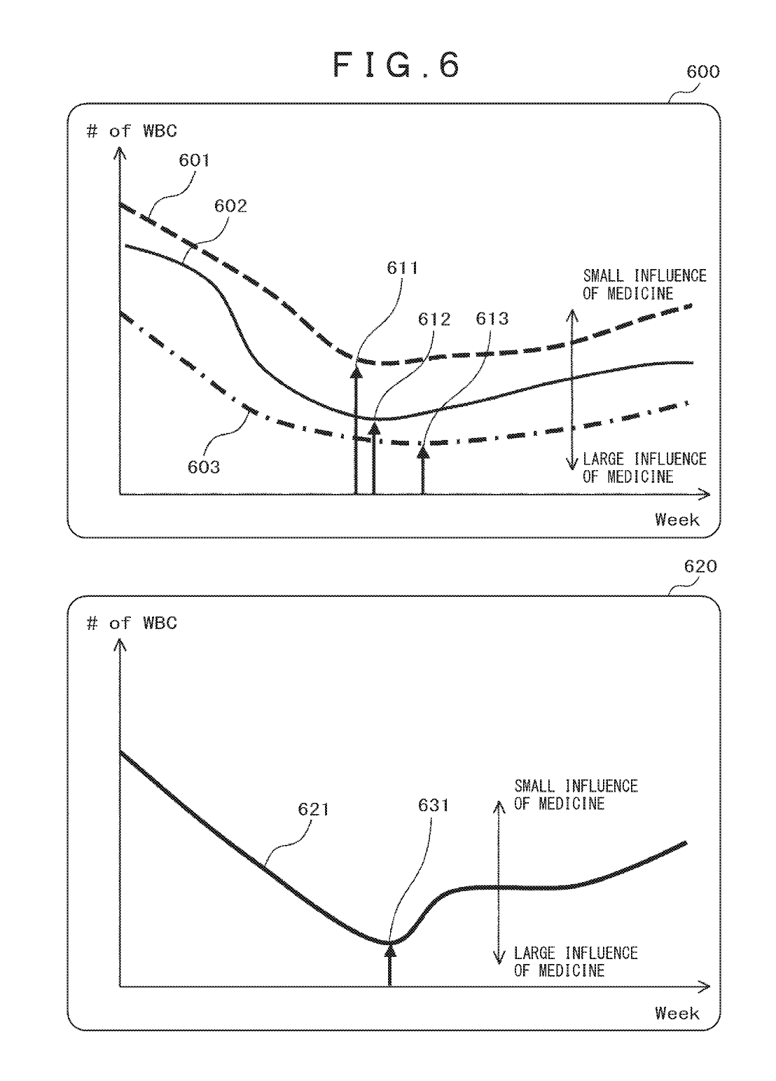

In S102, a transition of the test value of the test data 420 is modeled by regression from the intrinsic data 410. Modeling in the embodiments of the present invention means to obtain parameters (coefficients) of a regression formula for predicting and computing the test value 420 of the individual patient from the intrinsic data 410. An example illustrating a predicted test value 601 of a patient of ID=1 (431) and a predicted test value 602 of a patient of ID=2 (432) with parameters of the regression formula obtained by S102 is shown in FIG. 6. The following processing can be executed under various regression conditions using general regression, such as lasso regression (linear regression having introduced regularization), neural net regression, and support vector regression, that are described in Non-Patent Literature 1 (Bishop, Christopher M., and Nasser M. Nasrabadi, “Pattern recognition and machine learning.” Vol. 1. New York: springer, 2006) as techniques of regression. Incidentally, in the following, this embodiment is explained using regression (in this embodiment, referred to as deep learning regression) based on deep learning (Non-Patent Literature 2 (Bengio, Yoshua. “Learning deep architectures for Al.” Foundations and trends in Machine learning 2.1 (2009): 1-127.).

First, how to handle data is explained. The binary data 412 is extracted from the intrinsic data 410, and a value of 0-1 expression is substituted with the following formula.

[Formula 1]

v^{B}ε{0,1} (1)

For example, in the case of the data 412, male is represented by 0 (male=0) and female is represented by 1 (female=1). Moreover, from the intrinsic data 410, other piece of data that can take binary values, for example, data 414, is also replaced with the 0-1 expression by the same procedure.

Next, the multi-valued data 413 is extracted from the intrinsic data 410, and is replaced with a vector of 1-of-K expression (Non-Patent Literature 1 (Bishop, Christopher M., and Nasser M. Nasrabadi. “Pattern recognition and machine learning.” Vol. 1. New York: springer, 2006)

[Formula 2]

v^{M}ε{0,1}^{D}^{_{M}} (2).

For example, in the case where it is assumed that the patient's age ranges from 0 year old up to 100 years old, a dimensionality of the 1-of-K expression

[Formula 3]

D_{M} (3)

is 101, and a 0-year-old patient's data can be replaced with a 0-1 vector of 101 dimensions

[Formula 4]

v=(1,0, . . . ,0) (4)

Incidentally, other multi-valued data rows existing in the intrinsic data 410, for example, 415, are vectorized to be of the 1-of-K expression by the same procedure.

When the intrinsic data 410 is the data 416 of a rational number or real number, an element of V is set as follows

[Formula 5]

v^{R}εR (5)

and the value is used as it is. Incidentally, the symbol R of (Formula 5) means a real number. Moreover, values of test value 422 of the test data 420 are also handled as real values.

Incidentally, from a viewpoint of simplicity of processing, all pieces of the data existing in the intrinsic data 410 may be made into real values and be replaced with (Formula 5) described above. For example, in the case of the data 412, pieces of the data are substituted by male=0 and female=1, and then are regarded as real numbers. Moreover, in the case of the data 413, the patient's age is regarded as a real number and is used.

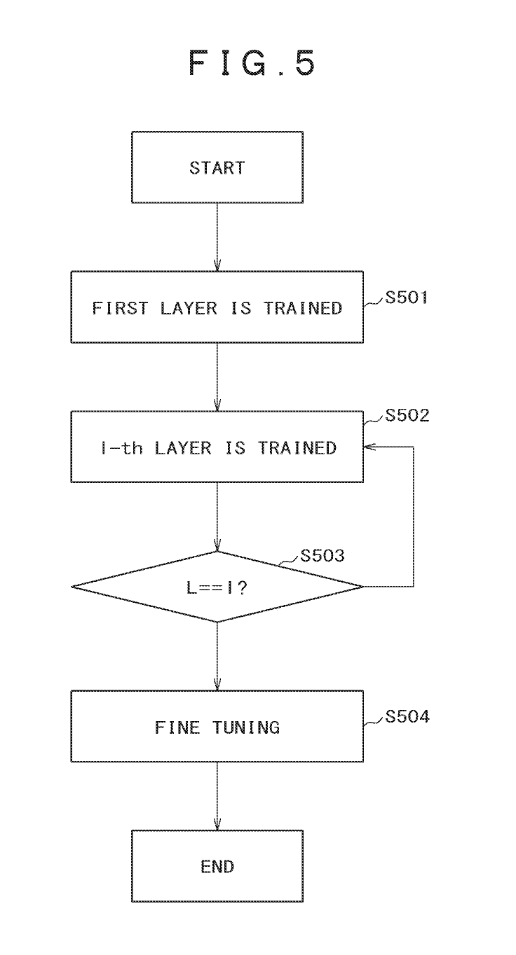

In the following, a procedure of obtaining the parameters of the regression formula for predicting and computing the test value 420 of the individual patient from the intrinsic data 410 by nonlinear multiple regression consisting of restricted boltzmann machines (RBM) of all L layers (L≧1) and a regression function of an (L+1)-th layer using the detailed processing flow of S102 shown in FIG. 5 is explained.

In S501, training of the RBM of the first layer is performed. The first layer is a vector sequence that uses the intrinsic data 410 as its inputs, the vector sequence being expressed by

[Formula 6]

v={t,v₁^{B},v₂^{B}, . . . ,v_{bn}^{B},v₁^{M},v₂^{M}, . . . ,vₘₙ^{M},v₁^{R},v₂^{R}, . . . ,vₘ^{R}} (6)

First, explaining each element of the vector v, t is a parameter representing a time (the number of weeks) of the test data 420; for example, in the case of data of a 421st row, t=1 is inputted. Incidentally, t is handled as a real value. V^{B} is a related factor of binary data taken out from the intrinsic data 410; for example, in the case of a patient of ID=1 of the related factor 412, “1” (male) is inputted. V^{M} is a related factor of multi-valued data taken out from the intrinsic data 410; for example, in the case of a patient of ID=1 of the related factor 413, 1 is inputted into an 82nd dimensional element of a 101-dimensional vector by the 1-of-K expression. V^{R} is a related factor of real value data taken out from the intrinsic data 410; for example, in the case of a patient of ID=1 of the related factor 416, 8.5 is inputted.

A gradient of the RBM of the first layer is calculated with the following formula.

$$\begin{matrix} [ Formula 7 ] & \\ \frac{\partial log p ( {v}^{( 1 )} )}{\partial {w}_{ij}^{( 1 )}} = {v}_{j}^{( 1 )} g ( {\sum }_{j}^{ } {w}_{ij}^{( 1 )} {v}_{j}^{( 1 )} + {c}_{i}^{( i )} ) - {\hat{v}}_{j}^{( 1 )} g ( {\sum }_{j}^{ } {w}_{ij}^{( 1 )} {\hat{v}}_{j}^{( 1 )} + {c}_{i}^{( 1 )} ) \\ \frac{\partial log p ( {v}^{( 1 )} )}{\partial {b}_{j}^{( 1 )}} = {v}_{j}^{( 1 )} - {\hat{v}}_{j}^{( 1 )} \\ \frac{\partial log p ( {v}^{( 1 )} )}{\partial {c}_{i}^{( 1 )}} = g ( {\sum }_{j}^{ } {w}_{ij}^{( 1 )} {v}_{j} + {c}_{i}^{( i )} ) - g ( {\sum }_{j}^{ } {w}_{ij}^{( 1 )} {\hat{v}}_{j}^{( 1 )} + {c}_{i}^{( 1 )} ) & ( 7 )\end{matrix}$$

Incidentally, p means a probability. An i-th element of the vector h^{(l)} of the first layer hidden unit is defined as

[Formula 8]

hᵢ⁽¹⁾ε{0,1} (8)

The function g is an activation function, and when

[Formula 9]

vᵢεv^{B} (9)

and

[Formula 10]

vᵢεv^{M} (10)

are satisfied, calculation is performed by specifying g as a sigmoid function. When

[Formula 11]

vᵢεv^{R} (11)

is satisfied, the calculation is performed by specifying g as a normal distribution. Next, parameters of an l-th layer are defined by

[Formula 12]

(θ^{(l)}:={W^{(l)},b^{(l)},c^{(l)}} (12).

W^{(l)} represents a parameter matrix of the l-th layer, and b^{(l)} and c^{(l)} represent bias spectra. The formula (Formula 7) is for a case of l=1 with subscripts i, j representing an element of the parameter.

[Formula 13]

\hat{v} (13)

is a vector of a data layer sampled by contrastive divergence (CD method) (Non-Patent Literature 3 (Hinton, Geoffrey, “A practical guide to training restricted Boltzmann machines,” Momentum 9.1 (2010))).

In the CD method, a parameter θ^{(l)} is calculated with a gradient descent method using the gradient of (Formula 7). After the calculation of the parameter, l is set to 2 (l=2) and the process proceeds to the next step S502. Incidentally, in the case where the element of the data layer v is NA like 417, when executing the CD method, the parameter θ^{(l)} is computed by inputting a random value in order to continue the calculation.

In S502, training of the RBM of the l-th layer is performed. A gradient of the RBM of the l-th layer is calculated with the following formula.

$$\begin{matrix} [ Formula 14 ] & \\ \frac{\partial log p ( {v}^{( l )} )}{\partial {w}_{ij}^{( l )}} = {v}_{j}^{( l )} sigm ( {\sum }_{j}^{ } {w}_{ij}^{( l )} {v}_{j}^{( l )} + {c}_{i}^{( l )} ) - {\hat{v}}_{j}^{( l )} sigm ( {\sum }_{j}^{ } {w}_{ij}^{( l )} {\hat{v}}_{j}^{( l )} + {c}_{i}^{( l )} ) \\ \frac{\partial log p ( {v}^{( l )} )}{\partial {b}_{j}^{( l )}} = {v}_{j}^{( l )} - {\hat{v}}_{j}^{( l )} \\ \frac{\partial log p ( {v}^{( l )} )}{\partial {c}_{i}^{( l )}} = sigm ( {\sum }_{j}^{ } {w}_{ij}^{( l )} {v}_{j} + {c}_{i}^{( l )} ) - sigm ( {\sum }_{j}^{ } {w}_{ij}^{( l )} {\hat{v}}_{j}^{( l )} + {c}_{i}^{( l )} ) & ( 14 )\end{matrix}$$

The function sigm is a sigmoid function. θ^{(l)} is calculated in the same way as S501 and the process proceeds to the next step S503.

In S503, if L==1, the process will proceed to S504; if L>l, l+1 will be substituted into l (l+1 [symbol] l) and the process will proceed to S502.

In S504, fine-tuning is performed. In doing this, as a regression function of the (L+1)-th layer,

[Formula 15]

y=f(x) (15)

is set, and the following formula based on linear regression is used.

[Formula 16]

f^{(L+1)}(x):=W^{(L+1)}v^{(L)}+b^{(L+1)} (16)

Here, V^{(L)} is an input vector and a hidden unit h^{(L)} of an L-th layer is used. y is an output vector and a value of the test data 420 is used. Incidentally, this embodiment explains an example where a value of the test data 420 of white blood cell is used, and y is regarded as a one-dimensional scalar. When obtaining multiple test values simultaneously, regression is simultaneously executed by inputting multiple kinds of test values (a lymphocyte count, a platelet count, etc.) into different elements of y. Then, to a neural network,

[Formula 17]

f(x):=W^{(L+1)}(sigm(W^{(L)}( . . . (sigm(W⁽¹⁾v⁽¹⁾+b⁽¹⁾) . . . )+b^{(L)})+b^{(L+1)} (17),

to which (Formula 16) was added as a final layer,
parameters of up to the (L+1)-th layer,

[Formula 18]

θ^{(l=1, . . . ,L+1)}:={W^{(l=1, . . . ,L+1)},b^{(l=1, . . . ,L+1)}} (18),

are copied, and subsequently all the parameters of (Formula 1X) are calculated with the gradient descent method.

[Formula 19]

v′=k^{(k)}+ε (19)

is saved in the memory 222 and the process proceeds to S103. Incidentally, once all the parameters θ are computed by S102, the predicted test values 601, 602, and 603 as shown in FIG. 6 are calculated as y by inputting the intrinsic data 410 into V, and at the same time, times 611, 612, and 613 at which the adverse event occurs strongly are computed as their minimums. Therefore, at which timing the adverse event occurs most strongly for each patient can be grasped. Moreover, it can be grasped what value of the related factor the patient has and to what degree of influence the patient is subjected by medication.

Incidentally, the steps of S501 to S503 may be omitted, and the neural net regression of (Formula 17) may be used directly. Moreover, general regression such as the support vector regression may be used.

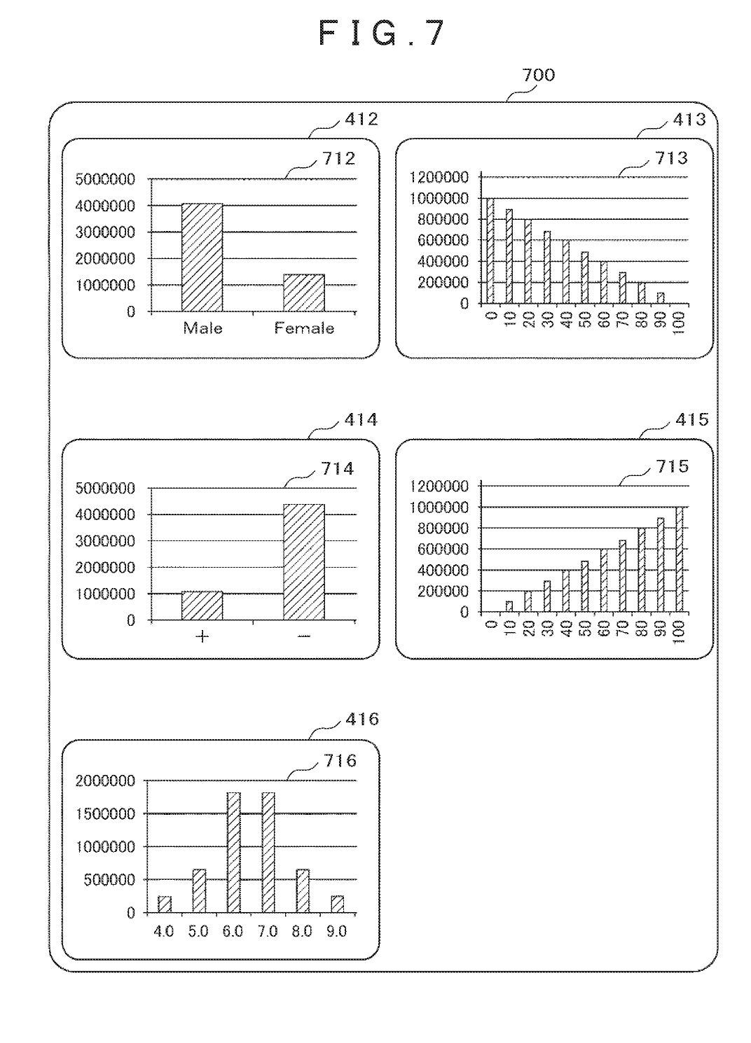

A transition of the blood count is modeled in S102, and this makes it possible to predict and compute the transition of the blood count for every week by inputting the intrinsic data 410. The intrinsic data 410 is transmitted from the client 200 to the analysis server 220, and the analysis processing unit 300 stores the received intrinsic data 410 in the health care data 400 shown in FIG. 4. In S103, virtual intrinsic data having the same related factors (412, 413, 414, - - - , 415, and 416) as those of the intrinsic data 410 of the patient is generated, and a frequency distribution is computed for a patient group (namely, a patient group whose variation of the test value becomes more than or equal to the fixed value by medication) to which the medicine gives a strong influence like the predicted test value 603 of FIG. 6. In the following, although a patient group whose test value falls below a fixed value at certain timing will be explained as an example, this also includes a case where the frequency distribution is computed for a patient group whose test value exceeds the fixed value at certain timing according to the kind of a medicine and the kind of a related factor. Illustrating in FIG. 7 an example of the frequency distribution predicted by S103, the frequency distribution corresponding to the related factor 412 is 712, with a vertical axis expressing a virtually computed number of patients and a horizontal axis expressing sex. A frequency distribution corresponding to the related factor 413 is 713; a vertical axis expresses the virtually computed number of patients, and a horizontal axis expresses age. A frequency distribution corresponding to the related factor 414 is 714; a vertical axis expresses the virtually computed number of patients, and a horizontal axis expresses existence of gene deletion. A frequency distribution corresponding to the related factor 415 is 715; a vertical axis expresses the virtually computed number of patients, and a horizontal axis expresses the radiation dose. A frequency distribution corresponding to the related factor 416 is 716; a vertical axis expresses the virtually computed number of patients, and a horizontal axis expresses the white blood count.

In the following, a distribution of the related factor that minimizes the blood count is efficiently computed using a Metropolis Hastings (MH) algorithm. In order to compute a distribution of patients whose white blood counts fall due to an action of the medicine, a vector v consisting of related factors of the intrinsic data whose predicted value y always takes a small value is computed.

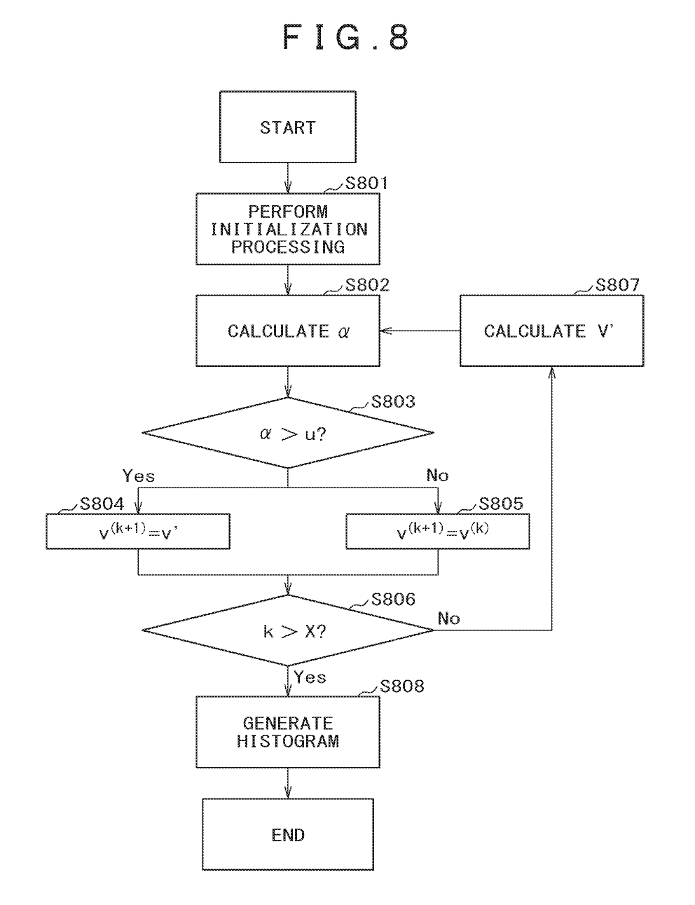

A flow showing an MH algorithm of processing of S103 is shown in FIG. 8. First, an initial value V^{(k=1)} is generated at random by S801, and ε taken out from the normal distribution is added to V^{(k)} to compute

[Formula 20]

v′=v^{(k)}+ε (20).

Incidentally, it should be noted that in contrast to S102, the subscript k means a repeat count of the MH algorithm.

Next, in S802, a probability α that the predicted value y may take a small value (probability that the above-mentioned vector v can be obtained) is calculated from the following formula.

$$\begin{matrix}[ Formula 21 ] & \\ α = \frac{q ( {v}^{( t )} \vert {v}^{′} )}{q ( {v}^{′} \vert {v}^{( t )} )} exp ( - \{ L ( {v}^{′} ) - L ( {v}^{( t )} ) \} / T ) & ( 21 ) \\ [ Formula 22 ] & \\ q ( {v}^{( t )} \vert {v}^{′} ) & ( 22 )\end{matrix}$$

is an arbitrary proposal distribution and, for example, a Gaussian distribution can be used. Here, in the case where the smaller the test value, the stronger the influence of the medicine is, the calculation is performed with the function L replaced with (Formula 16). Moreover, in the case where the larger the test value, the stronger the influence of the medicine is, the function L is calculated with the following formula.

$$\begin{matrix}[ Formula 23 ] & \\ L ( v ) = \frac{1}{f ( v )} . & ( 23 )\end{matrix}$$

In S803, a uniform random number u is calculated from a uniform distribution; when α>u is satisfied, the process proceeds to S804, and when it is not satisfied, the process proceeds to S805. In S804, the following formula is set.

[Formula 24]

v^{(k+1)}=v′ (24)

In S805, the following formula is set.

[Formula 25]

v^{(k+1)}=v^{(k)} (25)

Next, in S806, when k>10,000(X) is satisfied, the process proceeds to S808; when it is not satisfied, the process proceeds to S807. Moreover, let k increase by 1 (k+1 [symbol] k). A value of the repeat count k (namely, a value of X) can be defined arbitrarily. Next, in S807, ε taken out from the normal distribution is added to V^{(k)} as

[Formula 26]

v′=k^{(k)}+ε (26)

to compute V′.

In S808, a frequency distribution is generated for V^{(k)} of k=10,000 or more and the processing is ended. Incidentally, an example of the generated frequency distribution is shown in FIG. 7. The above is a flow of the processing in S103.

Next, in S104, statistical verification of a high occurrence related factor is performed. Specifically, a statistical test is applied to an individual frequency distribution generated by S103. When the related factor of the health care data 400 is binary, a group of the related factors having one value is designated as A and a group thereof having the other value is designated as B. For example, in the frequency distribution 712 of the related factor 412, males are classified into a group A and females are classified into a group B.

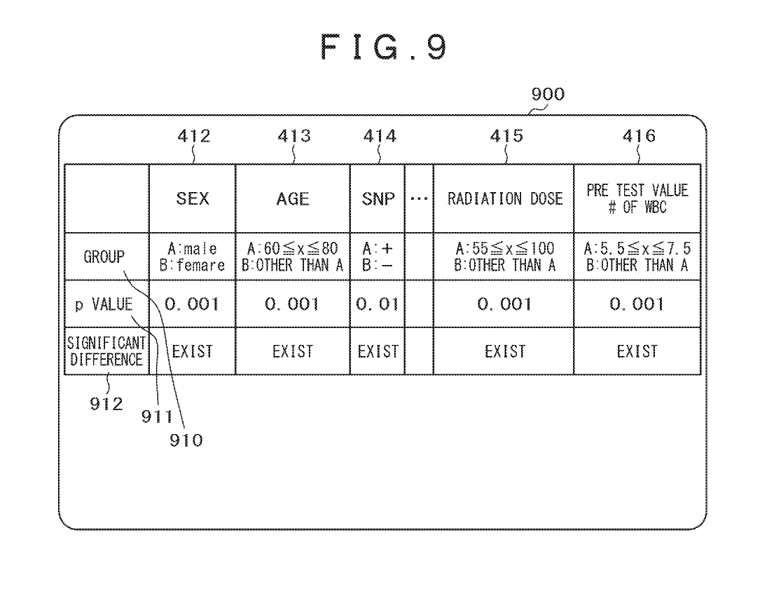

Next, in the case where the related factor of the health care data 400 is multi-valued and real valued, a section that contains 50% to X % (in this embodiment, X=80%) of total accumulative number in the frequency distribution is classified into a group A, and a section that is not contained in the group A is classified into a group B. For example, in the frequency distribution 713 of the related factor 413, a section is for patients not less than 60 years old and not more than 100 years old, and its portion becomes 80% (accumulative number of 4,400,000 among total accumulative number 5,500,000). An example where the patients are grouped with respect to the related factors 412, 413, 414, and 415 are shown in 910 of FIG. 9.

The statistical test is applied to the test values 420 of the group A and the group B that were computed from the frequency distributions 712, 713, 714, 715, and 716 computed from the health care data 400, and existence of the significant difference is computed. Incidentally, in this system, a p value is computed by performing a student's t-test on the white blood count values of the group A and the group B, and when the p value is less than or equal to 0.05, it is determined that there is the significant difference, which is outputted. Results of having computed the p value and the statistical significant difference are shown in 911 and 812 of FIG. 9, respectively, for the related factors 412, 413, 414, and 415. The above is a flow of processing in S104.

Next, in S105, risk information of the adverse event is transferred to the client. First, analytical data obtained by S101 to S104, that is, prediction test data 600 of FIG. 6, frequency distribution data 700 of FIG. 7, and statistical analysis data 900 of FIG. 8, are saved in the database 301 of the analysis server 220 as the analysis result 500.

The analysis result 500 of the database 301 is transferred to the client 200 through the network 210. Subsequently, a graph of FIG. 6 and the frequency distribution of FIG. 7 are displayed on the monitor 205.

### Second Embodiment

Hereinafter, a second embodiment of the present invention is described, taking a case where prediction of a medicine effect in the individual patient is performed as an example. Incidentally, although the explanation is given taking occurrence prediction of the adverse event of the anticancer agent as the example in the same way as the case of the first embodiment, the second embodiment is applicable to various adverse events in the same way as the case of the first embodiment. The health care data 400 on which the analysis is to be performed is stored in the database 301, which is saved in the HDD 221; and patient data 1102 on which the prediction is to be performed is stored in a client database 1101, which is saved in the HDD 201. In the second embodiment, by using data including the intrinsic data 410 of an actual patient as inputs on the assumption that the health care data 400 including the virtual intrinsic data generated in the first embodiment is in a state of being stored, an effect of a medicine after administration can be predicted for the patient. The analysis processing unit 300 is executed on the CPU 223 of the server 220.

Explaining the operation using FIG. 3, when the client terminal 200 establishes connection with the analysis server 220 through the network 210, the health care data 400 is called from the database 301 saved in the HDD 221, and the analysis processing unit 300 is executed by the CPU 223 to generate the analysis result 500 on the memory 222. Then, after the analysis result 500 is saved in the HDD 221, the analysis result 500 is distributed to the client terminal 200 through the network 210, and is displayed on the monitor 205. Furthermore, the patient data 1102 is called from the client database 1101 in the client terminal 200 to the analysis server 220 through the network 210, and a prediction processing unit 311 is executed by the CPU 223 of the server 220 to generate a predicted result 1103 on the memory 222. Then, the predicted result 1103 is saved in the HDD 221, and is distributed to the client terminal 200 through the network 210; and subsequently it is saved in the HDD 201 and is displayed on the monitor 205.

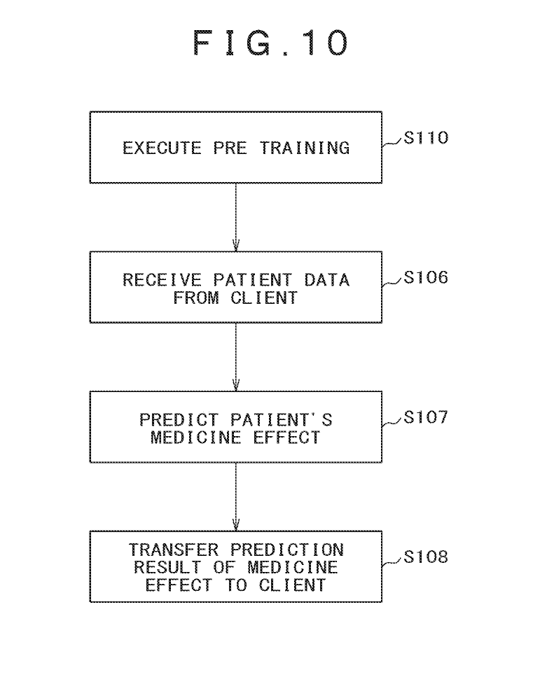

A flow of processing executed in the prediction processing unit 311 is explained using FIG. 10. First, in 5110, processing S101 to S105 is executed in the same way as the first embodiment.

Next, in S106, the patient data 1102 of a patient who is to be analyzed is read from the client database 1101. Here, explaining the patient data 1101 using FIG. 4, the patient data 1101 is such that a unique ID is assigned to the patient in the same way as the patient's own intrinsic data 410 shown in a first example, and data about the related factors 412, 413, 414, 415, and 416 described in the intrinsic data 410 is retained. Simply, the patient data 1102 is the patient's intrinsic data that is not included in the health care data 400.

In S107, an input vector v is calculated from the patient data 1101 by the same procedure as that of S102. Next, the predicted test value y is calculated with (Formula 16) using the regression parameters θ of all the L+1 layers calculated by S102. An example where a predicted test value 621 and an occurrence time 631 of the adverse event are drawn is shown in a graph 620 of FIG. 6.

In S108, the predicted test value of the adverse event obtained by S107 is transferred to the client 200 as the predicted result 1103 from the analysis server 220 through the network 210. After that, the predicted test value of the adverse event is displayed on the monitor 205 as the graph 620 as shown in FIG. 6.

The above is an operation example of the system of drug efficacy analysis by machine learning. Thus, in this system, since the analysis processing unit 300 performs regression analysis on the patient's related factor that is the factor information relating to occurrence of the adverse event and includes the test values before medication, models a transition of the test value after medication, virtually generates a related factor of a patient having the same related factor as the related information of the patient from the related factor of the patient whose transition of the test value was modeled, and generates a frequency distribution of each related factor for a patient whose variation of the test value by medication becomes more than or equal to a fixed value among patients having the generated related factors, it becomes possible to execute statistical analysis of medical practice data with a small number of samples. Moreover, since by the statistical test, the existence of the significant difference of the frequency distribution for each related factor is determined, the significant difference with respect to each related factor can be grasped. Furthermore, since the medicine effect of the patient who is to be analyzed is predicted based on both the related factor of the patient who is to be analyzed and the factor information of the patient whose transition of the test value was modeled, it becomes possible to predict the medicine effect after medication for each one of the patients.

1. A drug efficacy analysis method,
comprising:
a model generation step in which a regression analysis is performed on a patient's factor information that is factor information relating to occurrence of an adverse event and includes test values before medication and a transition of the test value after medication is modeled; and
a distribution generation step in which factor information of a patient having the same factor information as the factor information of the patient is virtually generated from the factor information of the patient whose transition of the test value was modeled, and a frequency distribution for each piece of the factor information is generated for a patient whose variation of the test value by medication becomes more than or equal to a fixed value among patients who have the generated factor information.

2. The drug efficacy analysis method according to claim 1,
further comprising a verification step of determining existence of significant difference of the frequency distribution by a statistical test.

3. The drug efficacy analysis method according to claim 1,
wherein in the model generation step, factor information relating to occurrence of side effects after medication as an adverse event is regression-analyzed.

4. The drug efficacy analysis method according to claim 1,
comprising a prediction processing step of predicting a medicine effect of a patient who is to be analyzed based on both the factor information of the patient who is to be analyzed and factor information of a patient whose transition of the test value generated in the model generation step was modeled.

5. The drug efficacy analysis method according to claim 1,
wherein in the model generation step, the factor information of the patient is regression-analyzed by neural net regression.

6. The drug efficacy analysis method according to claim 1,
wherein in the model generation step, the factor information of the patient is regression-analyzed by support vector regression.

7. The drug efficacy analysis method according to claim 1,
wherein in the model generation step, the factor information of the patient is regression-analyzed by deep learning regression.

8. A drug efficacy analysis system,
comprising:
a model generation unit that performs regression analysis on a patient's factor information that is factor information relating to occurrence of an adverse event and includes test values before medication, and models a transition of the test value after medication; and
a distribution generation unit that virtually generates factor information of a patient having the same factor information as the factor information of the patient from the factor information of the patient whose transition of the test value was modeled, and generates a frequency distribution for each piece of the factor information about a patient whose variation of the test value by medication becomes more than or equal to a fixed value among patients having the generated factor information.

9. The drug efficacy analysis system according to claim 8,
further comprising a verification unit for determining existence of the significant difference of the frequency distribution by a statistical test.

10. The drug efficacy analysis system according to claim 8,
wherein the model generation unit performs regression analysis on the factor information relating to occurrence of side effects after medication as an adverse event.

11. The drug efficacy analysis system according to claim 8,
comprising a prediction processing unit for predicting a medicine effect of a patient who is to be analyzed based on both the factor information of the patient who is to be analyzed and factor information of a patient whose transition of the test value generated in the model generation step was modeled.
